(19) United States
(12) Patent Application Publication
(10) Pub. No.: US 2019/0073091 A1
(43) Pub. Date: Mar. 7, 2019

(54) DYNAMIC DISPLAY LAYOUT SYSTEMS AND METHODS

(71) Applicant: SAP SE, Walldorf (DE)

(72) Inventors: Joshua Chisholm, Vancouver (CA); Henry Lo, Surrey (CA); Ivan Gonzalez, Vancouver (CA); Cynthia Lim, Vancouver (CA)

(73) Assignee: SAP SE, Walldorf (DE)

(21) Appl. No.: 15/697,300

(22) Filed: Sep. 6, 2017

(51) Int. Cl. G06F 3/0481; G06F 9/451

(52) U.S. Cl. CPC G06F 3/0481; G06F 9/451

(57) ABSTRACT

In one embodiment, the present disclosure pertains to dynamic display layout of electronic content. In one embodiment, content is displayed across a range of display sizes, where within certain ranges of display sizes, the content is scaled up or down in size, and across breakpoints the content is repositioned to optimize the presentation of the electronic content to a user. In one embodiment, widgets are associated with elements of a grid. The widgets define regions where content is displayed. The grid elements may be part of a page, where the width of different displays sets the page width, the size of the grid elements, and the size of the widgets and related content in the display.

### BACKGROUND

The present disclosure relates to computing and data processing, and in particular, to dynamic display layout systems and methods.

The explosive growth and diversity of computer systems has allowed users to interact with electronic content on displays across a wide range of devices. Displays come in a wide range of sizes, ranging from small cellular phones and tablets to laptops and desktops coupled to ever increasing screen sizes. However, it is often the case that the approach taken for presenting content on different devices can be dramatically different. For instance, content displayed on a large multiscreen projector system at a conference may be laid out and presented very differently than content displayed on a small cellular phone display, for example. Thus, presenting the same electronic content across a wide range of devices seamlessly can be a challenge.

The present disclosure provides techniques for improving the display of electronic content.

### SUMMARY

In one embodiment, the present disclosure pertains to dynamic display layout systems and methods. In one embodiment, the present disclosure pertains to dynamic display layout of electronic content. In one embodiment, content is displayed across a range of display sizes. Within certain ranges of display sizes, the content is scaled up or down in size, and across breakpoints the content is repositioned to optimize the presentation of the electronic content to a user. In one embodiment, widgets are associated with elements of a grid. The widgets define regions where content is displayed. The grid elements may be part of a page, where the width of different displays sets the page width, the size of the grid elements, and the size of the widgets and related content in the display, for example.

The following detailed description and accompanying drawings provide a better understanding of the nature and advantages of the present disclosure.

### BRIEF DESCRIPTION OF THE DRAWINGS

FIG. 1 illustrates dynamic display layout according to one embodiment.

FIG. 2 illustrates an example grid with scaling and repositioning of content according to various embodiments.

FIG. 3 illustrates pages, rows, and lanes according to various embodiments.

FIG. 4 illustrates object hierarchies for displaying content according to an example embodiment.

FIG. 5 illustrates mapping content to an example grid and lanes in a design mode according to an embodiment.

FIG. 6 illustrates displaying content on a display in a presentation mode according to an embodiment.

FIG. 7 illustrates displaying content on another display in a presentation mode according to an embodiment.

FIG. 8 illustrates displaying content on yet another display in a presentation mode according to an embodiment.

FIG. 9 illustrates dynamic content loading according to another embodiment.

FIG. 10 illustrates hardware of a special purpose computing machine configured according to the above disclosure.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

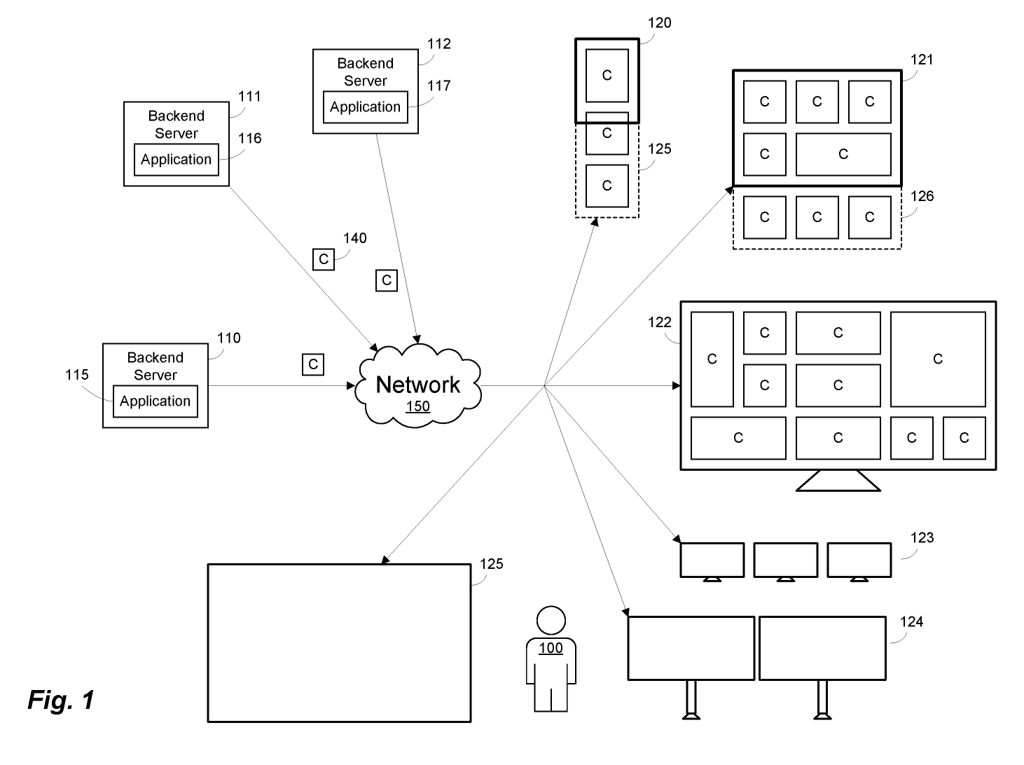

FIG. 1 illustrates dynamic display layout according to one embodiment. Features and advantages of the present disclosure include delivery of different content from a plurality of sources to a plurality of different display sizes, where content dynamically changes size and position within different displays to optimize view of the content to a user. For example, FIG. 1 illustrates numerous backend servers 110-112 running applications 115-117 that produce content “C”, such as content 140, for example. Backend servers and applications may be executed on computers (e.g., hardware servers) or virtualized machines in data centers, for example, and accessed over one or more networks 150, including the Internet. Applications may perform a wide range of functions and may process vast amounts of data, which may be stored in backend storage systems (e.g., databases), for example. Example applications may include Enterprise Resource Planning (ERP), Customer Relationship Management (CRM), Business Intelligence, Human Resource Management, or content management (video and/or audio), and the like, which may store data about inventories, supply chains, sales, revenues and costs, employees, and the like, for example. In some embodiments, content may be provided from websites, for example.

Features and advantages of the present disclosure include presenting processed data as electronic content to users across a wide range of display sizes, and automatically changing the way the content is displayed based on the display size to optimize presentation of the content to the user. One challenge with delivering the rapidly growing amount and type of content available through networks 150 is that different display technologies may require dramatically different content presentation layouts for optimum viewing. For example, if a large multi-display conference presentation system includes sections of the display for graphs, charts, graphics, video elements, and the like, such system cannot simply be reduced in size and presented on a mobile device, for example. The resulting display would be too small to be meaningfully understood by a user.

Embodiments of the present disclosure include organizing the content in a structured manner, and then dynamically sizing and positioning the content based on the particular display the content is targeted for. In one embodiment, content is mapped to a grid having grid elements (e.g., rectangular grid elements). For example, the grid elements may be sized based on a display area of the particular display. As the display area changes size, the grid changes size, and thus the content changes size. In one embodiment, as the display area increases or decreases, the grid elements increase or decrease, respectively, thereby automatically increasing or decreasing the content presentation in the display.

In one embodiment, content is resized (using resized grid elements) across ranges of display sizes, and content is repositioned in different ranges (e.g., across a breakpoint) for optimum viewing. For example, breakpoints may be specified between display area sizes across different ranges—e.g., between a first range corresponding to a range of laptop display sizes and another range corresponding to a range of mobile device screen sizes. In one embodiment, within one range of display area sizes, grid elements scale, or change size with, different display area sizes. Accordingly, electronic content mapped to the grid elements also changes size as the display area size changes. However, when a display area size is within a different range (e.g., across a breakpoint), then the content may be repositioned in the display, for example. In one example embodiment, breakpoints are based solely on width of the display area of the target device.

In another embodiment, the grid elements are associated with a plurality of lanes, which may encompass multiple grid elements, and electronic content may be associated with particular lanes when the content is associated with the grid elements in a lane, for example. When displayed on different display sizes, the lanes, and the content in the lanes, may be scaled or repositioned. For example, lanes may be defined during a design time (e.g., preview or edit time in a design mode), and specify regions of a display encompassing particular grid elements. Content may then be mapped to different grid elements in different lanes, for example. In a presentation mode, lanes may be configured horizontally (e.g., side-by-side) for display areas having a width greater than a first threshold (e.g., on the higher side, in width, of a breakpoint), and lanes may automatically be configured vertically (e.g., one on top of the other, where content is accessibly by scrolling) for display areas having a width less than a second threshold (e.g., on the lower side, in width, of the breakpoint). Within particular ranges of display sizes, the content and the lanes may scale based on scaling of the grid elements as mentioned above, for example.

In one embodiment, content is presented in the display according to a specified order corresponding to a position of the content in the display (e.g., upper left to lower right), and a width of the display area controls the layout of content in the display. As the display area width changes (e.g., across a breakpoint), content is repositioned according to the specified order, where content higher in the ordering is viewable in the upper left of the display area, and content lower in the ordering is viewable in the lower right or removed from the display and viewable by scrolling down, for example.

Referring again to FIG. 1, content from numerous external content sources may be configured to be displayed on a plurality of different devices. For example, content 140 may be display on mobile phones 120 having a range of display sizes, tablets 121 having another range of display sizes, desktop monitors 122 have another range of display sizes, multiple desktop monitors 123 having another range of display sizes, one or more big screen displays or televisions 124 having yet another range of display sizes, or a multi-screen conference display or projection system 125 having yet another range of display sizes. Embodiments of the present disclosure may include configuring content in a design mode to associate the content with elements of a grid of a display. In a presentation mode, the content either scales in size with the size of the target display or the content is repositioned to optimize viewing. For example, as illustrated at 125 and 126, content for smaller displays may be repositioned vertically below other content so that it is accessible by scrolling down, for example. Conversely, as the display size increases, the content may be repositioned in the display. As described in more detail below, content within particular ranges of display sizes (e.g., tablet display sizes) may be scaled up or down in size without repositioning, for example.

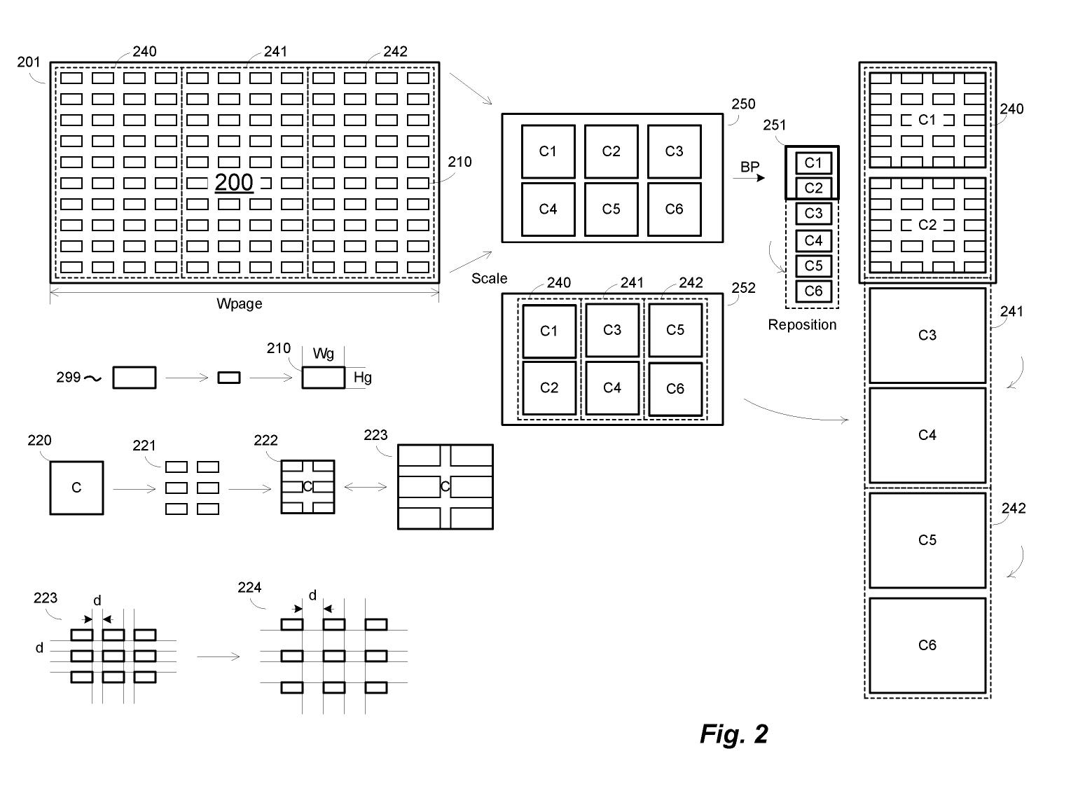

FIG. 2 illustrates an example grid with scaling and repositioning of content according to various embodiments. In this example, a grid 200 is displayed in a display area 201 (also referred to as a page). In this example, grid 200 comprises rectangular grid elements 210 having a rectangular aspect ratio comprising a width Wg and a height Hg. In other embodiments, the grid elements may be displayed differently. Grid elements may be arranged in columns and rows across page 201, for example. In this example, grid elements are separated by a grid spacing, d, which in some embodiments may be programmable, for example. Thus, the total width of a page 201, Wpage, is the number of grid elements (e.g., N) in a row multiplied by the grid element width, Wg, and added to the number of grid spacings (e.g., N−1) in a row multiplied by the spacing, d:

Wpage=N*Wg+(N−1)*d.

The grid elements and grid spacing may be mapped to a wide range of display sizes. For example, in one embodiment, grid 200 may be mapped to a display having a width of Wp pixels and height of Hp pixels. Using the above equation and a programmed value for the spacing, d (in pixels), the grid element width, Wg, may be calculated as follows:

Wg(in pixels)=[Wp−(N−1)*d]/N.

Accordingly, grid element widths may be scaled to different display sizes based on the width of the display area of the target device. In one embodiment, scaling is based solely on display area width of the target display. Therefore, in one embodiment, the height of each grid element may be based on, and less than, the width of the grid element. For example, in one embodiment, the grid element width is Wg and the grid element height is Wg/3. Scaling of the grid element is illustrated at 299 in FIG. 2. As the target device display decreases, the grid element width and height decrease, but maintains a constant aspect ratio. Conversely, as the target device display increases, the grid element width and height increase.

Features and advantages of the present disclosure include associating electronic content with particular grid elements. In one embodiment, content is represented by widgets, which are associated with electronic content. Widgets define areas on a display where electronic content associated with the widgets may be displayed. For example, content widget 220 may be a square box in a display. Content widget may be associated with metadata and/or configuration information, for example, to access particular electronic content from a backend application (e.g., a particular sales graph, a geospatial data map, a video, or a webpage). Accordingly, the electronic content is presented in a location specified by widget 220. In this example, content widget 220 is associated with, or mapped to, grid elements 221. In one embodiment described in more detail below, widgets are dragged and dropped onto grid 200 in a edit mode (also known as design mode), and the widgets may be sized to encompass multiple whole grid elements vertically and horizontally. For example, widgets may be dragged onto the page 201 and may snap in line with the grid elements as illustrated at 222. Thus, grid elements 221 specify a size and location for displaying the electronic content for widget 220 on grid 200 of page 201. In this example, once the page layout is completed and widgets mapped to various grid elements on the page, the layout design may be deployed for presentation across multiple different displays of different devices (e.g., in a presentation mode). For example, if a widget is displayed on a large display with a large width, in pixels, the grid elements may increase in size, as described above, and the size of the content widget increases with the grid elements it encompasses as illustrated at 223, for example. Accordingly, widgets and the electronic content they display may be scaled up and down as shown at 222 and 223 based on the display width.

FIG. 2 further illustrates variable grid spacing according to an embodiment. In this example, grid spacing, d, may be programmable as illustrated at 223 and 224. Here, grid spacing, d, is the same both vertically and horizontally. However, programmable grid spacing may change only the vertical grid spacing, only the horizontal grid spacing, or set both spacings to the same or independent values, for example.

As mentioned above, once content widgets are mapped to grid elements on page 201, the content may be displayed and automatically scale across different devices. Another aspect of the present disclosure advantageously repositions widgets across different ranges. For example, display 250 includes six content widgets displayed as two rows and three columns. However, simply scaling down the size of the content widgets for display on mobile device 251 could potentially render the content too small to be useful. Accordingly, breakpoints are specified between ranges of display sizes. When content is displayed on a target device in another range, which may have a display width less than a threshold, for example, the content may be scaled and repositioned, for example. As illustrated in FIG. 2, when content on display 250 is displayed on mobile phone display 251, crossing a breakpoint (BP), then the content is repositioned vertically, for example, to allow the content to occupy a larger number of pixels of the display width than would be allowed without repositioning. In this example, the six items of content are repositioned vertically (one on top of the other), and a user may access some of the content outside/below the display by scrolling down, for example.

Some example embodiments of the present disclosure may advantageously reposition content according to an order. For example, an order may be assigned to widgets associated with grid elements based on locations of grid elements encompassed by the particular widgets. For example, widgets in display 250 may be ordered from the top-left of the display to the bottom-right of the display to produce the following order: C1, C2, C3, C4, C5, C6, where C1 is highest in the order and C6 is lowest in the order. Accordingly, the electronic content associated with widgets C1-C6 may be repositioned based on the order for different displays having different display sizes. For example, electronic content associated with a higher order widget, such as C1, is repositioned to the left of electronic content associated with a lower order widget, such as C2, when the display width is above a threshold as in display 250, and electronic content associated with the higher order widget, C1, is repositioned above electronic content associated with a lower order widget, C2, when the display width is below the threshold, as in mobile device display 251. In the example shown for mobile device display 251, the content is repositioned one on top of the other to maximize the size of each item of content displayed. A wide variety of repositioning arrangements may be made based on the ordering described herein, further examples of which are illustrated below.

FIG. 2 further shows another aspect of some embodiments. In this example, a display area, or page, may be divided into a plurality of lanes. In this example, grid 200 on page 201 is divided into 3 equal width lanes 240-242. Lanes may be used to control how content is repositioned across breakpoints. For example, when a content widget is associated with grid elements in lane 240, the content widget is also associated with lane 240. Similarly, other content widgets associated with grid elements in lane L1 240 are associated with lane L1 240, content widgets associated with grid elements in lane L2 241 are associated with lane L2 241, and content widgets associated with grid elements in lane L3 242 are associated with lane L3 242, for example. In one embodiment, the lanes may be assigned an order from left to right [L1, L2, L3], for example, and the content in each lane may be assigned an order from top left to bottom right. When the layout design is deployed on a display having a width greater than a particular breakpoint, the lanes may be arranged horizontally (e.g., side by side). For example, page 201 may have 3 lanes with content C1-C6 as displayed on display 252. In this example, C1 and C2 are associated with lane 240, C3 and C4 are associated with lane 241, and C5 and C6 are associated with lane 242. Advantageously, the ordering described above is applied per lane, so the ordering for lane 240 is [C1, C2], the ordering for lane 241 is [C3, C4], and the ordering for lane 242 is [C5, C6]. When the layout is displayed on a mobile device, for example, with a display width less than a threshold, the lanes are repositioned vertically according to an assigned order [L1, L2, L3], for example. Accordingly, L1 240 is positioned at the top with associated content C1 and C2 displayed, L2 241 is positioned below L1 with associated content C3 and C4 viewable by scrolling down, and L3 242 is positioned below L2 with associated content C5 and C6 also viewable by scrolling down, for example.

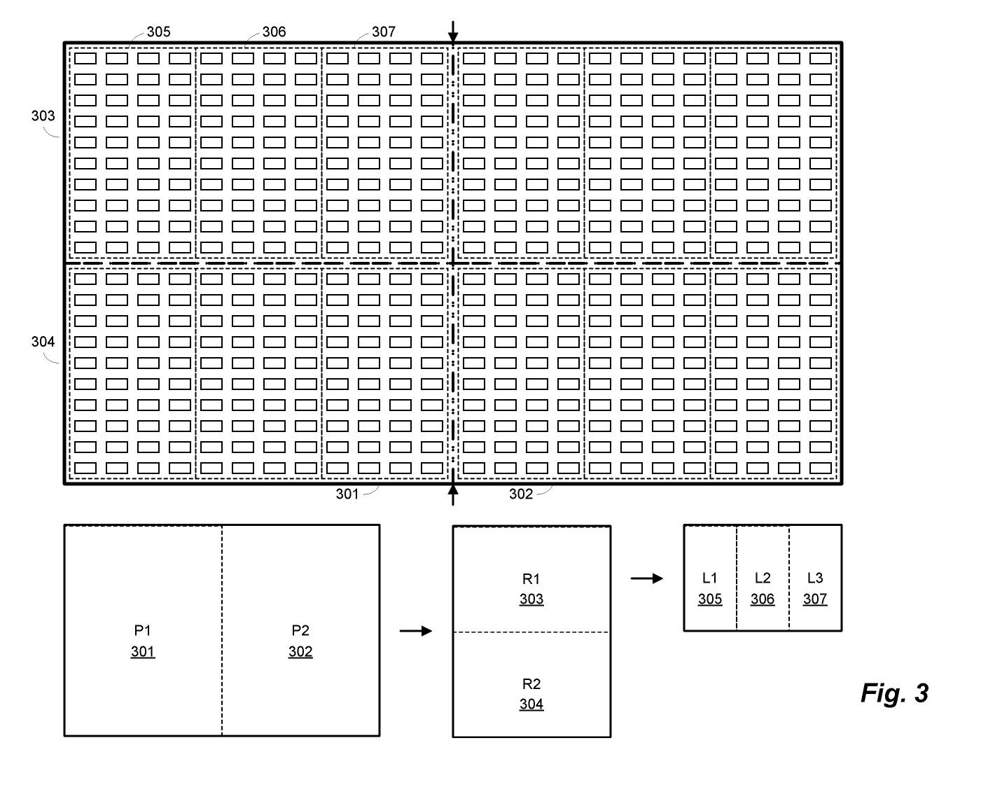

FIG. 3 illustrates pages, rows, and lanes according to various embodiments. In some embodiments, users may specify lanes, rows, and additional pages for very large or complex content layouts. In this example, a user is presented with a grid and the user may divide the grid into two pages 301 and 302 associated with different grid elements, which in this example divides the grid into two equal pages of grid elements. The pages may be assigned an order as described above, where page P1 and P2 are ordered as [P1,P2] and may be displayed horizontally for display widths greater than a threshold Th1 or vertically, with P1 above P2, for display widths less than a threshold Th2 (Th1>=Th2), for example. Similarly, a user may specify rows inside one or more pages. Rows are associated with rows of grid elements, for example, and are displayed vertically (one of top of the other). For example, rows 303 and 304 may be associated with grid elements in one of pages 301 or 302, for example. Finally, lanes may be specified by a user for each page or row, for example, and associated with particular grid elements in the corresponding page or row. In this example, lanes 305-307 may be included in page 301 and row 303, for example.

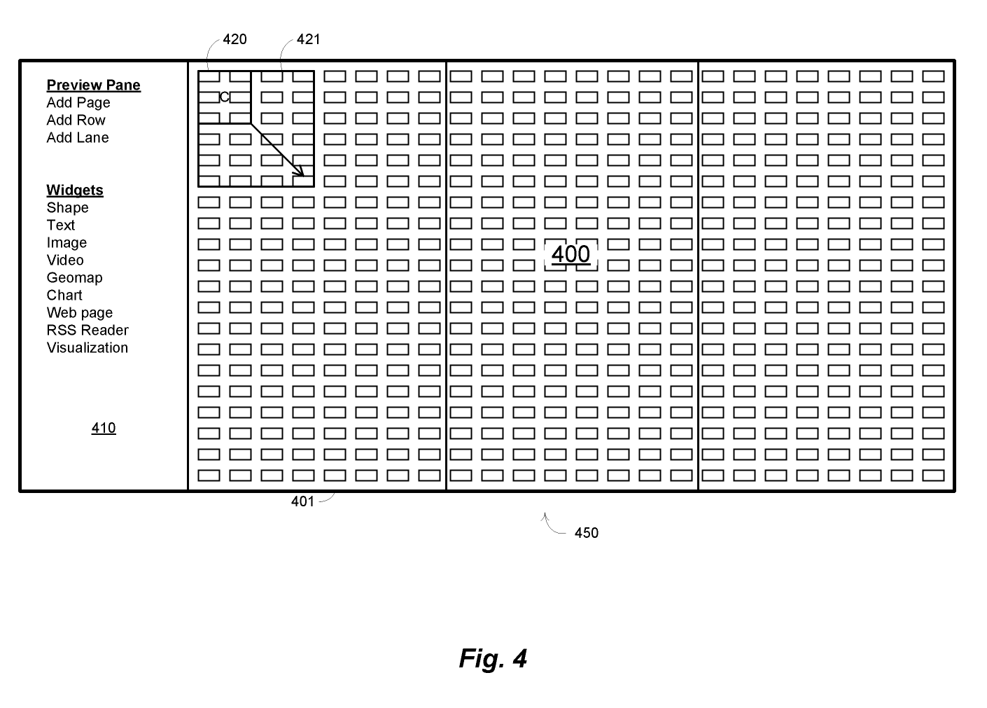

FIG. 4 illustrates mapping content to an example grid and lanes in a design mode according to an embodiment. In one embodiment, a user is presented with a user interface (UI) 450 with a grid 400 for designing a layout of content for display across different sizes of displays, for example. In this example, UI 450 includes a menu 410 including options for adding pages, rows, and lanes to a preview pane comprising grid 400. In this example, three lanes have been added to grid 400. Menu 410 further includes widgets that may be selected and added by a user to grid 400. Widgets include, but are not limited to, shapes, text, images, videos, geomaps, charts, web pages, RSS Readers, and visualizations (e.g., data visualizations), for example. In this example, a content widget 420 has been selected and positioned in the upper left corner of lane 401 of grid 400. Widget 420 may have a square or rectangular shape with sides that snap to edges of grid elements, for example. A user may position widget 420 to cover any grid elements on grid 400 and resize the edges of the widgets to create different sizes for displaying the content relative to the page size, for example. As illustrated here, widget 421 may be resized at 421 to cover more grid elements, for example. A user may further specify configuration information for each widget to connect to a desired backend system, specify particular data and/or charts, graphs, videos, or any other externally available content, and display the content in the window defined by the widget, for example. As mentioned above, the page width may be related to the grid element width and/or grid spacing, and thus the content displayed in the widget area may be sized relative to the page width during presentation by setting the page width equal to the width of the target display, for example.

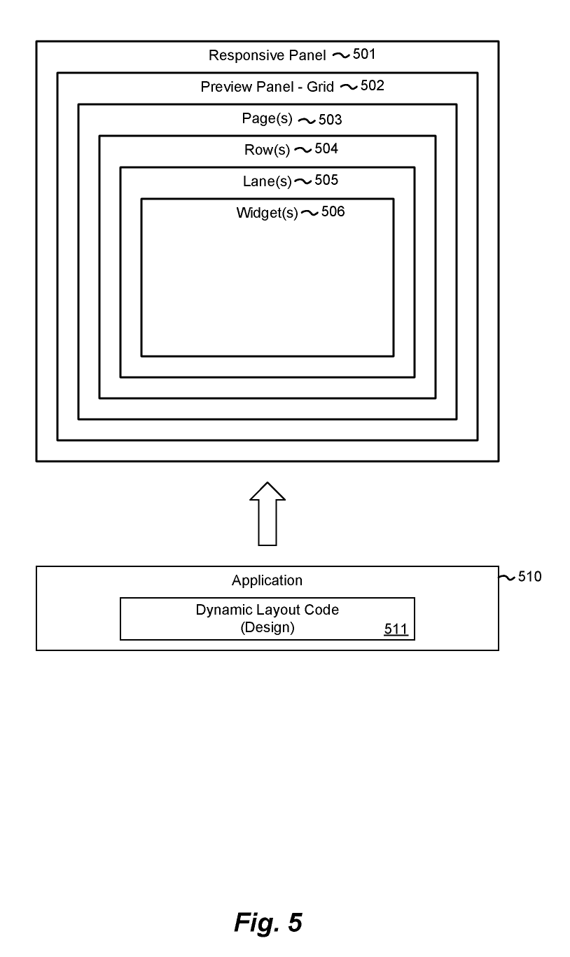

FIG. 5 illustrates object hierarchies for displaying content according to an example embodiment. In one example embodiment, designing a dynamic layout may be performed by an application 510 including dynamic layout code 511, for example. In one embodiment, the dynamic layout code 511 may generate objects including a responsive panel 501, preview panel/grid 502, pages 503, rows 504, lanes 505, and widgets 506. Responsive panel 501 includes a preview/design panel 502 including a grid as illustrated in FIG. 4, for example. As mentioned above, one or more pages 503 may be included in the grid, and one or more rows 504 may be included in particular pages. One or more lanes 505 may be included in particular rows (if any) and particular pages, for example. Finally, content widgets 506 may be included in lanes (if any), rows (if any) or pages. Embodiments of a responsive panel may include an application 510 where a user creates/designs a content layout, and the content layout is deployed to devices having a wide range of display sizes with a local application that optimizes the presentation of the content as described herein. In some embodiments a dynamic display layout may be interpreted by separate presentation software, for example the SAP Digital Boardroom®. For example, in one embodiment, digital boardroom application content is created within an editor/designer application (e.g., SAP Analytics Cloud®). The digital boardroom presentation may be presented from an editor/designer application, but it may also be deployed to work solely on a “consumption/interpreter” application (e.g., SAP Digital Boardroom Windows App). Such an application does not have creation/design capabilities but may consume/interpret the content (pages, lanes widgets), for example. In another embodiment, an editor/designer (e.g., SAP Analytics Cloud) may have a standalone iOS Application may be used solely for the consumption and interpretation of the Dynamic Display Layout, for example.

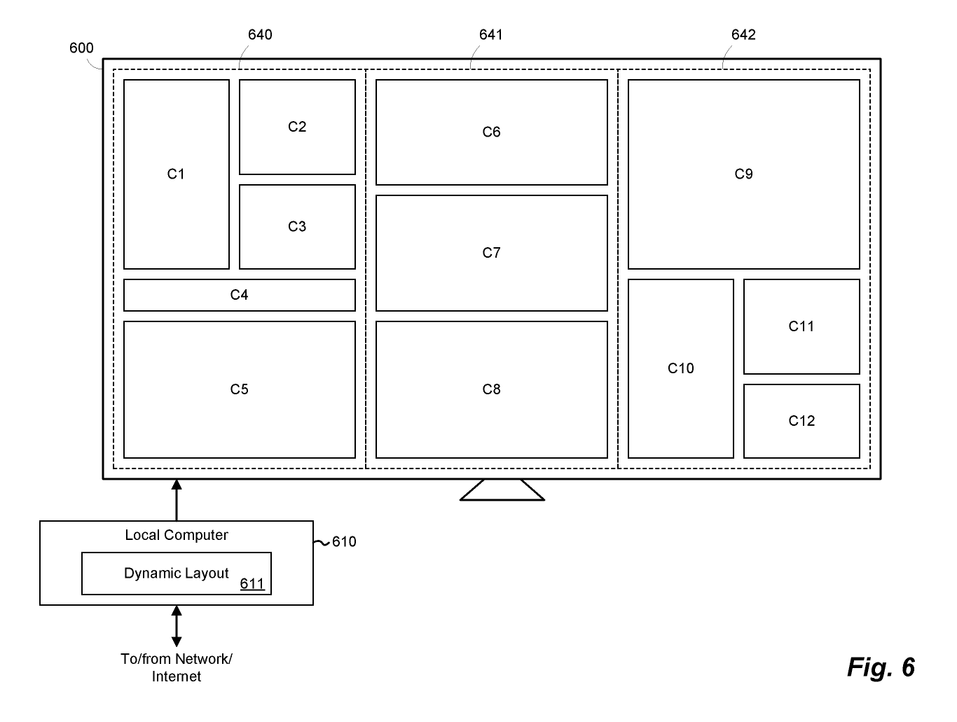

FIG. 6 illustrates displaying content on a display in a presentation mode according to an embodiment. In some embodiments, a user may design a layout of one or more pages, and the content may be displayed on a variety of devices. In this example, a dynamic layout is received in a local computer 610 over a network and a dynamic layout software system 611 presents pages, rows, lanes, and/or widgets in a display 600 based on the width of the target display. In this example, display 600 may be a large screen display (e.g., mounted on a wall in a conference room). This example page comprises 3 lanes 640, 641, and 642, which are displayed horizontally based on the large display width of display 600, for example. Lane 640 includes content C1-C5, which may have the following order [C1, C2, C3, C4, C5] based on a top-left to bottom-right ordering, for example. Content C1 is positioned at the (0,0) coordinate (e.g., row/column in grid elements) on the page based on C1 encompassing the grid element in the top row and the left-most column. Grid elements may not be shown in presentation mode, for example. If C1 has dimensions (N×M), then C2 is placed at the (0,M). Similarly, C4 is placed at the (N,0) position. Accordingly, the placement of widgets and the electronic content they display may be determined based on the dimensions (e.g., height and width) of other widgets in the display, for example, as well as the display width as described in more detail below. Similarly, lane 641 includes content C6-C8 and lane 642 includes content C9-C12 with a layout as shown.

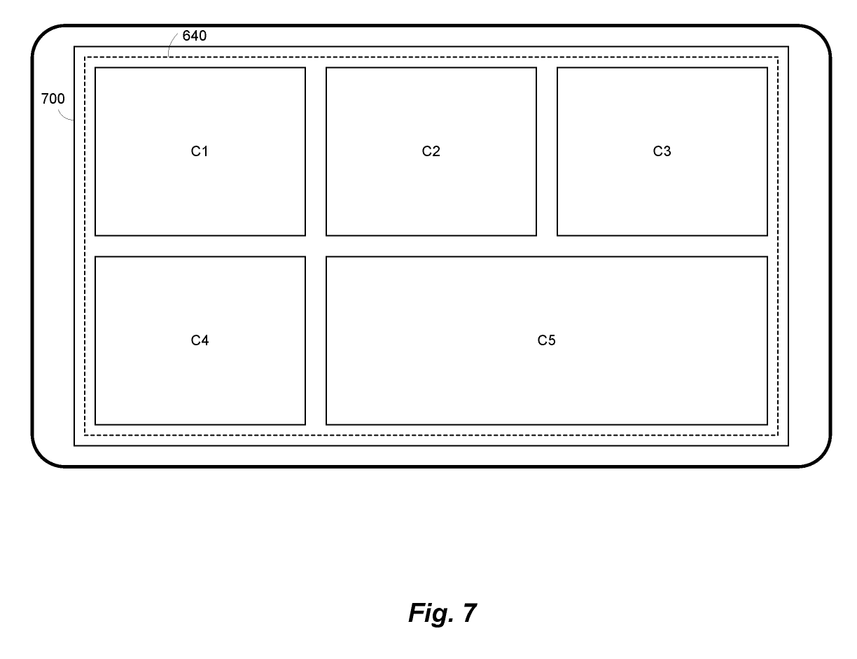

FIG. 7 illustrates displaying content on another display in a presentation mode according to an embodiment. In this example, widgets and their content are displayed on a tablet display screen 700 having a width that is less than the width of display 600 of FIG. 6. In this example, the width of display 700 is less than a threshold defining a breakpoint. Accordingly, lanes are repositioned vertically and only lane 640 is visible in the display, while lanes 641 and 642 may be viewed by scrolling down, for example. Due to the different display width, the widgets/content have also been repositioned. In this example, content C1-C5 is repositioned according to the ordering established during design time based on the location of each widget relative to the (0,0) position, for example. Further, in this particular implementation, each widget is resized according to a default size (e.g., widgets are sized to 50% of the width and the height is set to be equal to the width to maintain a square aspect ratio). A last widget, C5, is set to a size to fill the screen, for example, with a width equal to 2× widgets C2 and C3, for example. Accordingly, embodiments of the disclosure may include particular display width ranges corresponding to particular devices (e.g., a tablet) where default widget/content sizes may be applied and where last widgets are set to fill the screen, for example.

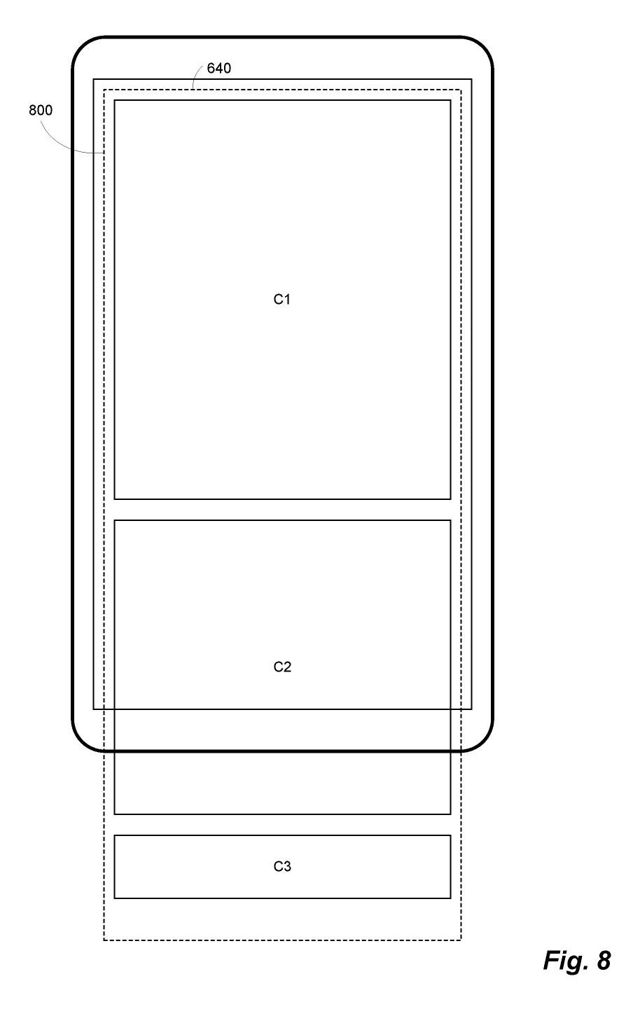

FIG. 8 illustrates displaying content on yet another display in a presentation mode according to an embodiment. In this example, widgets and their content are displayed on a mobile phone display screen 800 having a width that is less than the width of tablet display 700 of FIG. 7. In this example, the width of display 800 is less than another threshold defining a breakpoint. Due to the different display width, the widgets/content have also been repositioned. In this example, content C1-C5 is repositioned vertically according to the ordering mentioned above, for example. In this example, the width of C1 is set to the full width of the display 800 for optimum viewing based on the width of the display and the sizing of the grid elements encompassed by C1, for example. Other content in the ordering is positioned vertically, one on top of the other. C2 is partially visible, for example, and C3-C5 in lane 640 may be viewed by scrolling. Similarly, lanes are repositioned vertically and content in lanes 641 and 642 (not shown) may be viewed by scrolling down, for example. In one embodiment, the aspect ratio defined during design time (e.g., for C1 as shown in FIGS. 6 and 8) may be maintained across devices, whereas the default aspect ratio in FIG. 7 was 50% (or square), for example.

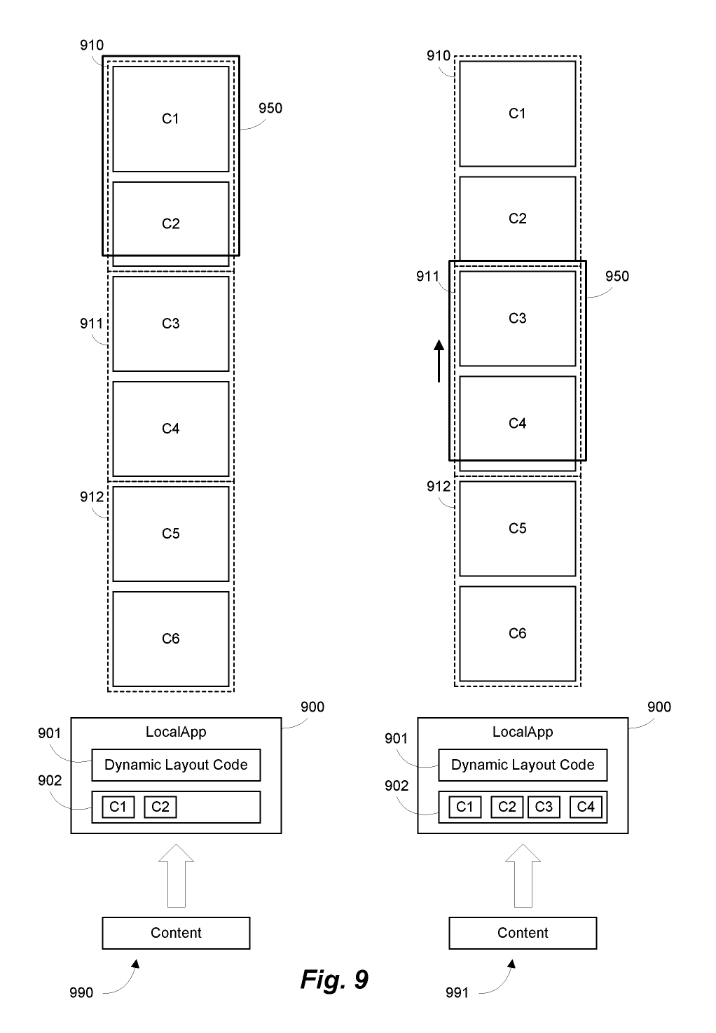

FIG. 9 illustrates dynamic content loading according to another embodiment. In this example, electronic content C1-C6 are included in lanes 910-911 for display on a mobile phone 950, for example. A local application 900 on mobile phone 950 may include dynamic layout code 901 for presenting electronic content based on display width, grid element scaling, widget placements, and lanes, for example. Here, a first lane 910 may include content C1 and C2, a second lane 911 may include content C3 and C4, and a third lane may include content C5 and C6. Due to the display size limitations, only C1 and a portion of C2 may be viewable, initially at 990, in the display of device 950. Features and advantages of the present disclosure may include additional code configured so that only content being displayed, or alternatively, content within a particular lane or range, may be downloaded into local memory from external sources to reduce the memory usage and reduce download times for displaying the content. For example, if a layout includes many items of content from many different remote systems that require large amounts of local memory, it may take a long time to download all the content and/or impair the speed of the device by using large amounts of local memory (e.g., RAM). Accordingly, if only content C1 and C2 are visible (e.g., as in case 990), then dynamic layout code 901 may only download content C1 and C2 into local memory 902, for example. Code 901 may, for example, determine content outside the display based on the display height, the coordinates of the content, and the size of intervening content, for example. Alternatively, content may be loaded on a lane by lane basis. For example, if content for a lane 910 is visible in the display, then all the content for that lane may be downloaded. In this example, C1 and C2 are in the same lane, so content for C1 and C2 may be downloaded, but content C3-C6 is not. Code 901 may determine lane heights for different lanes based on the widget sizes and placements in each lane, for example. If a user scrolls down such that content C3 is visible as illustrated at 991, content C4 in the same lane 911 may be downloaded and stored in memory 902 before it is visible, for example. These techniques may be referred to as “lazy loading.” In other embodiments, content in a predetermined range outside of the display may be loaded into local memory and content in a location beyond that range may not be loaded into local memory. For example, the system may determine that up to 4 pieces of content outside the display may be loaded, while other content beyond that may not be. As another example, the system may determine that partially displayed lanes may be loaded as well as one or more full lanes outside the display (e.g., lanes 910 and 911, but not lane 912). In addition to the techniques described above, code 901 may determine content within the range and content outside the range using a variety of information, including display height or width, widget heights and widths for the particular display (which may vary according to display width as described above), coordinates of the widgets, and lane, row, and page dimensions, if applicable, for example.

### Hardware

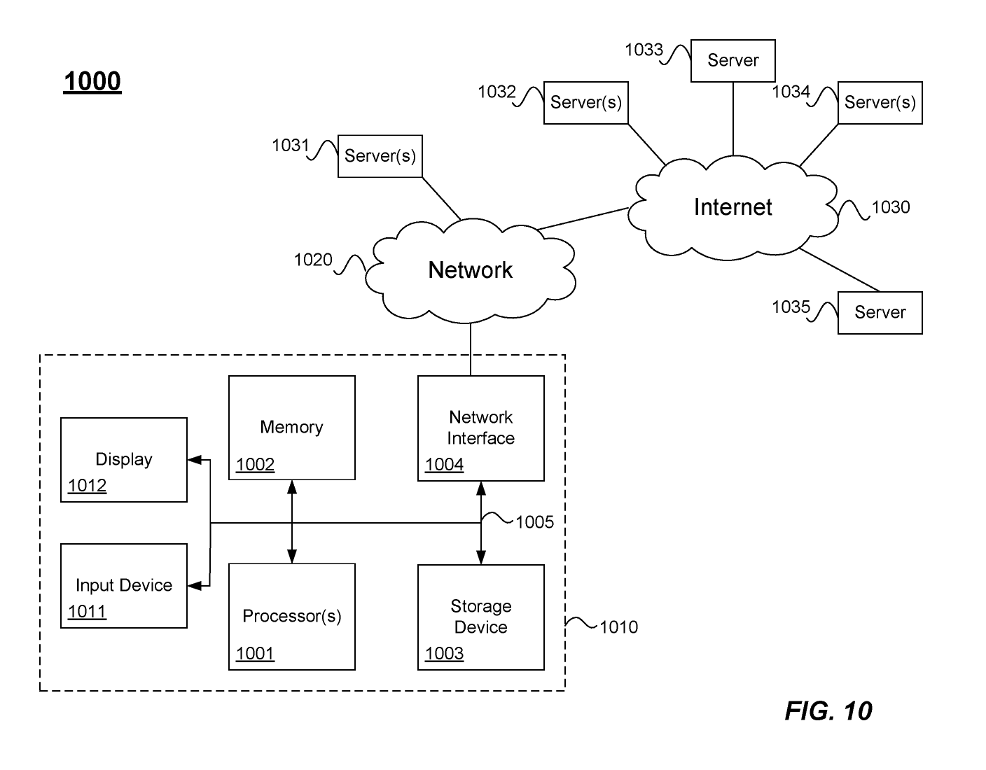

FIG. 10 illustrates hardware of a special purpose computing machine configured according to the above disclosure. The following hardware description is merely one example. It is to be understood that a variety of computers topologies may be used to implement the above described techniques. An example computer system 1010 is illustrated in FIG. 10. Computer system 1010 includes a bus 1005 or other communication mechanism for communicating information, and one or more processor(s) 1001 coupled with bus 1005 for processing information. Computer system 1010 also includes a memory 1002 coupled to bus 1005 for storing information and instructions to be executed by processor 1001, including information and instructions for performing some of the techniques described above, for example. Memory 1002 may also be used for storing programs executed by processor(s) 1001. Possible implementations of memory 1002 may be, but are not limited to, random access memory (RAM), read only memory (ROM), or both. A storage device 1003 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 1003 may include source code, binary code, or software files for performing the techniques above, for example. Storage device 1003 and memory 1002 are both examples of non-transitory computer readable storage mediums.

Computer system 1010 may be coupled via bus 1005 to a display 1012 for displaying information to a computer user. An input device 1011 such as a keyboard, touchscreen, and/or mouse is coupled to bus 1005 for communicating information and command selections from the user to processor 1001. The combination of these components allows the user to communicate with the system. In some systems, bus 1005 represents multiple specialized buses for coupling various components of the computer together, for example.

Computer system 1010 also includes a network interface 1004 coupled with bus 1005. Network interface 1004 may provide two-way data communication between computer system 1010 and a local network 1020. Network 1020 may represent one or multiple networking technologies, such as Ethernet, local wireless networks (e.g., WiFi), or cellular networks, for example. The network interface 1004 may be a wireless or wired connection, for example. Computer system 1010 can send and receive information through the network interface 1004 across a wired or wireless local area network, an Intranet, or a cellular network to the Internet 1030, for example. In some embodiments, a browser, for example, may access data and features on backend software systems that may reside on multiple different hardware servers on-prem 1031 or across the Internet 1030 on servers 1032-1035. One or more of servers 1032-1035 may also reside in a cloud computing environment, for example.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A method comprising:
displaying a grid in a display area, the grid comprising a plurality of grid elements;
associating the grid elements with a plurality of widgets, wherein widgets define areas where electronic content associated with the widgets are displayed, and wherein the particular grid elements associated with particular widgets specify a first location for displaying the electronic content;
determining a display width of a display of a computing device; and
displaying the electronic content associated with the widgets in the display,
wherein, across one or more ranges of display widths, a size of the grid elements changes as the display width changes to change a size of the electronic content in the display without repositioning the electronic content, and
wherein, across one or more breakpoints between the one or more ranges of display widths, the electronic content is repositioned to different locations for different displays having different display widths.

2. The method of claim 1 wherein the grid elements are rectangular, the grid elements having an aspect ratio comprising a width and a height.

3. The method of claim 1 wherein the grid elements are spaced apart by a programmable grid spacing.

4. The method of claim 1 wherein the widgets are in line with the grid elements to encompass whole grid elements.

5. The method of claim 1 further comprising assigning an order to the plurality of widgets associated with grid elements, wherein the order assigned to particular widgets is based on locations of the grid elements encompassed by the particular widgets, wherein the order is from the top-left of the display to the bottom-right of the display, and wherein the electronic content is repositioned based on the order for different displays having different display sizes.

6. The method of claim 5 wherein electronic content associated with a higher order widget is repositioned to the left of electronic content associated with a lower order widget when the display width increases above a threshold, and wherein electronic content associated with the higher order widget is repositioned above electronic content associated with a lower order widget when the display width decreases below the threshold.

7. The method of claim 5 wherein placement of widgets and corresponding electronic content in the display, in a presentation mode, is determined based on dimensions of each widget in the display, the order, and the display width.

8. The method of claim 1 further comprising specifying a plurality of lanes encompassing different pluralities of grid elements and associated widgets, wherein when a display width is greater than a first threshold corresponding to a breakpoint, the lanes are displayed horizontally, and when a display width is less than a second threshold corresponding to a breakpoint, the lanes are displayed vertically.

9. The method of claim 8 wherein the lanes are assigned a first order and the widgets in each lane is assigned a second order to control the repositioning of the lanes and the electronic content across a plurality of display widths.

10. The method of claim 1 wherein electronic content in a predetermined range outside of the display is loaded into local memory and content in a location beyond the predetermined range is not loaded into local memory.

11. A non-transitory machine-readable medium storing a program executable by at least one processing unit of a device, the program comprising sets of instructions for:
determining a display width of a display of a computing device; and
displaying electronic content associated with a plurality of widgets in the display,
wherein grid elements are associated with the plurality of widgets and the widgets define areas where electronic content associated with the widgets are displayed, and wherein particular grid elements associated with particular widgets determine a location for displaying the electronic content;
wherein, across one or more ranges of display widths, a size of the grid elements changes as the display width changes to change a size of the electronic content in the display without repositioning the electronic content, and
wherein, across one or more breakpoints between the one or more ranges of display widths, the electronic content is repositioned to different locations for different displays having different display widths.

12. The non-transitory machine-readable medium of claim 11 wherein the grid elements are rectangular, the grid elements having an aspect ratio comprising a width and a height.

13. The non-transitory machine-readable medium of claim 11 wherein the grid elements are spaced apart by a programmable grid spacing.

14. The non-transitory machine-readable medium of claim 11 wherein the widgets snap in line with the grid elements to encompass whole grid elements.

15. The non-transitory machine-readable medium of claim 11 further comprising instructions for assigning an order to the plurality of widgets associated with grid elements, wherein the order assigned to particular widgets is based on locations of the grid elements encompassed by the particular widgets, wherein the order is from the top-left of the display to the bottom-right of the display, and wherein the electronic content is repositioned based on the order for different displays having different display sizes.

16. The non-transitory machine-readable medium of claim 15 wherein electronic content associated with a higher order widget is repositioned to the left of electronic content associated with a lower order widget when the display width increases above a threshold, and wherein electronic content associated with the higher order widget is repositioned above electronic content associated with a lower order widget when the display width decreases below the threshold.

17. The non-transitory machine-readable medium of claim 15 wherein placement of widgets and corresponding electronic content in the display, in a presentation mode, is determined based on dimensions of each widget in the display, the order, and the display width.

18. The non-transitory machine-readable medium of claim 11 further comprising instructions for specifying a plurality of lanes encompassing different pluralities of grid elements and associated widgets, wherein when a display width is greater than a first threshold corresponding to a breakpoint, the lanes are displayed horizontally, and when a display width is less than a second threshold corresponding to a breakpoint, the lanes are displayed vertically.

19. The non-transitory machine-readable medium of claim 18 wherein the lanes are assigned a first order and the widgets in each lane is assigned a second order to control the repositioning of the lanes and the electronic content across a plurality of display widths.

20. The non-transitory machine-readable medium of claim 11 wherein electronic content in a predetermined range outside of the display is loaded into local memory and content in a location beyond the predetermined range is not loaded into local memory.
